(19) United States
(12) Patent Application Publication
(10) Pub. No.: US 2006/0153635 A1
(43) Pub. Date: Jul. 13, 2006

(54) Bar connector assembly

(76) Inventor: Daniel Charles Underwood, Balmoral (AU)

Correspondence Address: FITZPATRICK CELLA HARPER & SCINTO, 30 ROCKEFELLER PLAZA, NEW YORK, NY, 10112, US

(21) Appl. No.: 10/561,268

(22) PCT Filed: Jun. 21, 2004
(86) PCT No.: PCT/AU04/00815

§ 371 Date: Dec. 19, 2005

(30) Foreign Application Priority Data
Jun. 19, 2003 (AU) 2003903079

(51) Int. Cl. B25G 3/18

(52) U.S. Cl. 403/329

(57) ABSTRACT

A connector (10) and a U-shaped section of reinforcing bar (11) secured within the connector by a retainer (14). The connector (10) is symmetrical about the axial line (12) so that a corresponding reinforcing bar (11) may be located in the opposite side of the connector. The connector includes a seat section (13) and a retainer section (14). The seat section (13) includes opposed D-shaped lands (15) and (16) defining thereabout channels (17) and (18) into which the curved sections (19) of reinforcing bars (11) can be located and positioned. The retainer (14) includes a T-shaped projection (20) that extends transverse straight across the connector and serves to block compressive movement of the bars. The lands (15) and (16) inhibit deformation of the U-shaped bars when they are placed under tension. The projection (20) of the retainer and its engagement with the seat section serves to apply an outward force to the bars and an inward force to the lands (15) and (16) as the retainer is driven into place.

### FIELD OF THE INVENTION

THIS INVENTION relates to a bar connector assembly and in particular but not limited to a bar connector assembly used to couple or connect U-shaped ends of adjacent reinforcing bars and preferably couple them in a common plane.

### BACKGROUND TO THE INVENTION

It is customary to use lap bars projecting from a slab of concrete to connect bars in an adjacent slab. One example is where lap bars are used in a wall rebate to connect a floor to the wall.

In DE 3634568 (DENNERT KG VEIT) there is described a tensioning element for the frictionally locking connection of prefabricated concrete compound units (prefabricated floor slab) having a basic body and at least one tensioning member which is rotatably mounted in the basic body. As tensioning member, use is made of an eccentric shaft which is laid in a reinforcing loop of the prefabricated concrete compound units and, with its eccentric circumference, acts on the rounded portion of the loop from the inside. The eccentric shaft can rotate relative to the reinforcing loop, as a result of which the tensioning part is produced. The tensioning part of the eccentric shaft is configured as a flat cylindrical eccentric disk.

In JP10140670 (SUMITOMO CONSTRUCTION CO LTD) there is described a reinforcement connecting structure between precast concrete blocks, so that reinforcements arranged respectively in two precast concrete blocks can be firmly connected to each other. The reinforcement connecting structure comprises U-shapedly bent reinforcements respectively buried in two precast concrete blocks and the U-shaped curved parts are exposed in the vicinity of the joint end of the concrete blocks. Both the blocks are arranged so the curved parts of the reinforcements are arranged in two concrete blocks in confronting relation and a pair of saddle-like lock metal fittings in contact with the inside of the respective curved parts. These lock metal fittings are connected together through bolts and nuts, and are fastened so as to introduce a little tension to the reinforcements on both sides.

Each of the aforementioned connectors employ mechanisms which actively tension the opposed loops but in each case the connectors do not take into account compression that may occur over time. In addition the application of the connector requires adjustment, in the case of the German patent, the eccentric shafts have to be adjusted, in the case of the Japanese patent the nuts have to be adjusted and this process can be time-consuming where a large number of connectors are being used.

It is an object of the present invention to alleviate at least to some degree the aforementioned problems of the prior art.

### OUTLINE OF THE INVENTION

In one preferred embodiment the present invention resides in a bar connector assembly comprising a body having a bar seat section and a bar retainer moveable relative to the seat section to enable entry of a bar into the assembly, the seat section being adapted to receive and position a second bar relative to an adjacent bar connected to the assembly, the retainer being moveable between a first position allowing the second bar to be placed on the seat section and a second position to block removal of the second bar from the assembly.

In another preferred form the present invention comprises a connector assembly for connecting together opposed reinforcement bars wherein at least one of the bars comprises a loop section, the connector assembly having a main body and a separate bridging member, the main body having an opening and a loop section seat accessible through the opening so that the loop section may be secured to the main body when positioned on the seat, the bridging member being adapted to bridge across the opening when it is coupled to the main body, the other bar being otherwise connected to the main body opposite the loop section seat, the relative dimensions of the bars, the main body and the bridging member being so chosen and arranged that a rigid portion of the assembly is located between the bars to resist compressive forces which may tend to force the bars toward each other and a further rigid section of the assembly is located in the loop section to resist deformation of the loop section when under tension. The bridging member in this embodiment corresponds to the retainer of the first mentioned embodiment.

Typically the bar connector assembly enables connection of bars to the assembly so that bars extend from the connector in opposite directions. The bars typically have ends configured so that the ends mat be held captive in the assembly. One or both bars may be single bars having an end projection that fits into the main body and is held captive. For example, the end may be T-shaped. The end may be U-shaped and so on.

Preferably, the seat section comprises a curved channel into which a curved section of bar is positioned, the channel being at a boundary of an upstanding land filling the inside of the curved section so that upon a load being applied to the bar in tension, the land section aids in retaining the bar in position and inhibits its deformation.

The retainer preferably comprises a solid piece driven in to secure the second bar in position. The retainer typically comprises an edgeways slidable member able to slide into the body after the bar has been inserted, the bar in combination with the seat section and the retainer serving to secure the retainer and thereby the bar in position in the seat section. The retainer preferably bridges across opposite sides of the body such that the body and retainer have at least one of the bars located between them.

Preferably the assembly is symmetrical so that two identically shaped curved bars are connected together by the assembly with the bars so connected together occupying a common plane. The bars are typically U-shaped ends of projecting rebars of known type.

The main body preferably includes a retainer guideway and the retainer has a guide that travels on the guideway, the guide and/or guideway having a slight taper so that the retainer is wedged in position. In this embodiment where the bar is curved the retainer generates a clamping force on the curved section of the bar with an outward force applied in the direction of tension and an inward force opposite the outward force.

Typically, any gaps between the bars are filled by the assembly so that compressive movement is blocked and the assembly is symmetrical in terms of force distribution in side view with the main body resisting tension on one side of the reinforcing bars and the retainer bridging the opposite side of the reinforcing bars to resist tension so that force applied to the bars is distributed evenly through the assembly.

Preferably, the second bar is curved and the retainer generates a clamping force on the curved section of the bar with an outward force applied in the direction of tension and an inward force opposite the outward force.

Preferably, the second bar is curved and the retainer is wedged against the second bar.

Preferably, the assembly has two opposed seats and both bars are curved having curved sections in confronting relation when located in operative position and the retainer is wedged between the bars.

Preferably, the assembly has two opposed seats defined as the inner peripheral portion of opposed lands and both bars are curved having curved sections in confronting relation and wrapped around the respective lands when located in operative position and the retainer is wedged between the bars applying an outward force to the bars and bridges across the lands applying an inward force to each of the lands tending to prevent separation of the lands when tensioned.

### BRIEF DESCRIPTION OF THE DRAWINGS

In order that the present invention can be more readily understood and put into practical effect, reference will now be made to the accompanying drawings which illustrate a preferred embodiment of the invention and wherein:—

FIG. 1 is a side view of a connector assembly according to the present invention;

FIG. 2 is a section through A-A of FIG. 1;

FIGS. 3 and 4 are exploded views;

FIGS. 5 and 6 are assembled views from opposite sides; and

FIG. 7 is a view similar to FIG. 1 with slight modification.

### METHOD OF PERFORMANCE

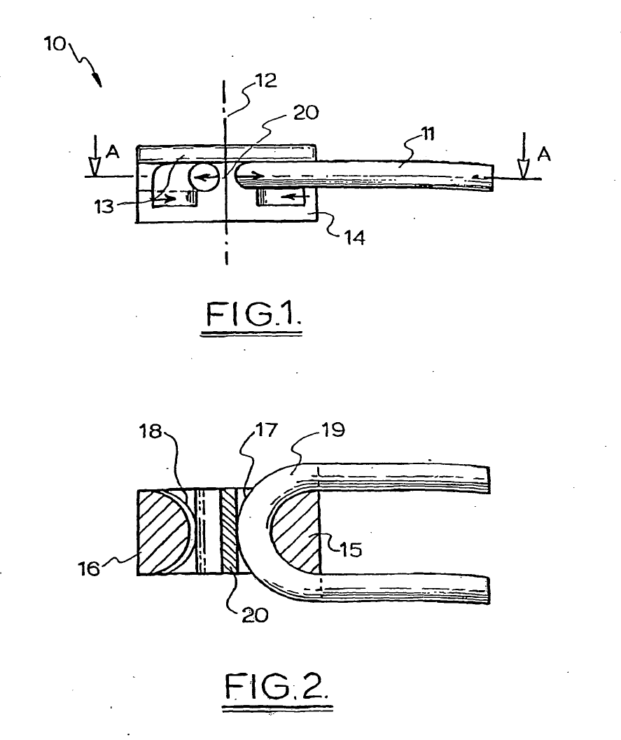

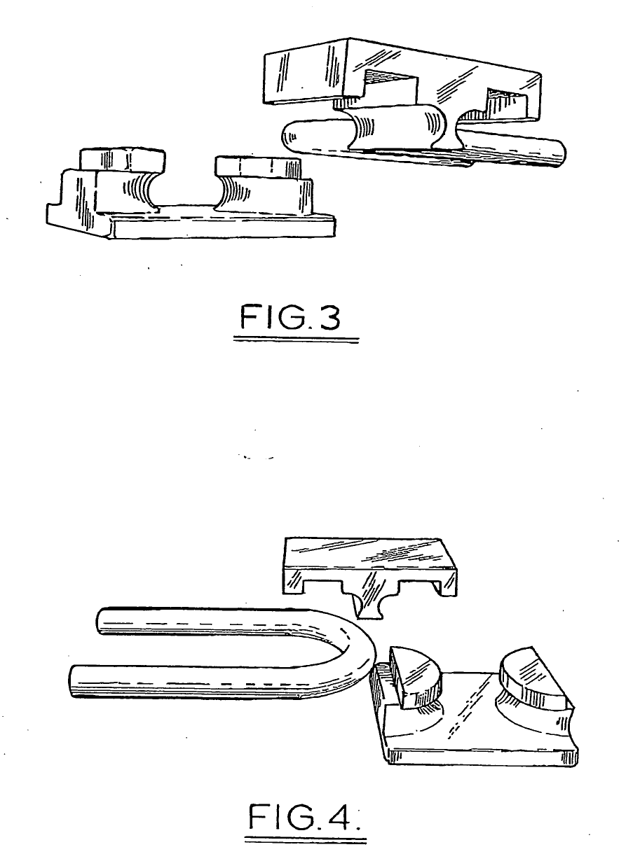

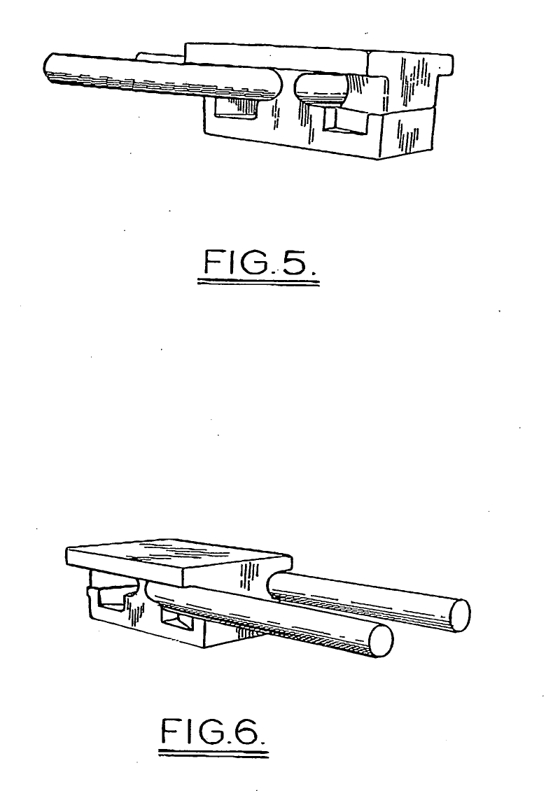

Referring to the drawings and initially to FIGS. 1 and 2, there is illustrated a connector 10 and a U-shaped section of reinforcing bar 11 secured within the connector. It will be appreciated that the reinforcing bar 11 does not constitute part of the present invention. The connector 10 in this case is symmetrical so that a corresponding reinforcing bar 11 may be located in the opposite side of the connector as will be described below. The reinforcing bar has been omitted from the opposite side so that the features of the opposite side may be illustrated more clearly, it being appreciated that the connector is symmetrical about the axial line 12.

The connector includes a seat section 13 and a retainer section 14. The seat section 13 includes opposed D-shaped lands 15 and 16 defining thereabout channels 17 and 18 into which the curved sections 19 of reinforcing bars 11 can be located and positioned, the retainer 14 includes a T-shaped projection 20 that extends transverse straight across the coupling as can clearly be seen by the hatch section in FIG. 2. The projection 20 abuts the bars in a wedging action and applies a slight outward force while at the same time inhibits compression that might otherwise cause the bars to move together thereby cracking the concrete. The D-shaped lands act in tension to keep the shape of the loop sections and prevent the loop section closing.

The seat section and the retainer section are cast iron selected according to appropriate loading as would be desirable in a concrete floor or wall construction or any application where the connector may be used according to engineering specifications.

Thus, the loops 11 would typically project from a concrete wall construction or floor construction and be connected to reinforcing in an adjacent structure using the connector 10. Since the retainer is located in position by a transverse sliding action the relative dimensions of the body, the retainer and the bar may be selected so that the retainer may be driven into position and it is the tangential engagement which retains the retainer in a secured position against the loop section 19. Alternatively, the mating sliding surfaces of the seat section and retainer may have slight taper so that the retainer is wedged in place. The taper may be on one or the other or both. Thus in FIG. 1 the arrows demonstrate the effect of the retainer being secured to the seat section, with that portion of the retainer in contact with the bars generating an outward force on the bars in the direction of tension and the retainer further generating an inward force on the D-shaped lands 15 and 16 effectively clamping the curved sections of bar. This also inhibits spreading of the D-shaped lands when tensioned.

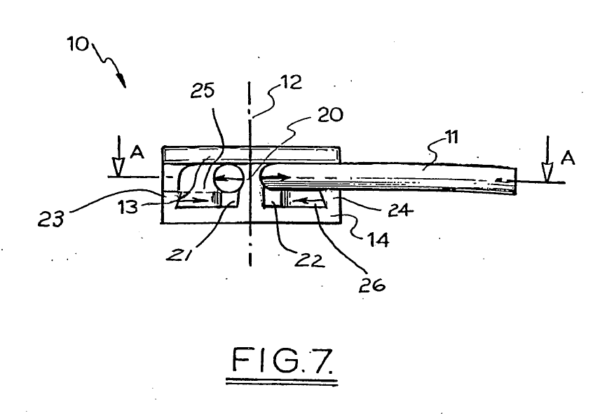

It will be appreciated that the present invention resides in connecting opposite bars together using a two part assembly that blocks the effect of tension and compression. This can be where in one half of the connector it may be preferable to have a loop bar in some circumstances of the type illustrated at 11, and this may be coupled to a single bar threadedly inserted into the seat section opposite the loop. It will be appreciated that this can be accomplished with bars in the same plane by slight modification of the seat section to extend and for the retainer on the opposite side to extend to accommodate a threading of the seat section so that the single bar and the loop 11 are located in the same plane. In this arrangement of course, the connector will not be symmetrical in side view. This is one example of a modification that would be apparent to those skilled in the art without departing from the broad ambit and scope of the invention as herein set forth. Another variation might be to create a retainer which bridges across the D-shaped lands and either the retainer or lands have projections that project through opening in the other and are retained in place by a wedges. The disadvantage with this arrangement, of course, is that it involves extra parts. FIG. 7 illustrates in further variation. Like numerals illustrate like features. In this embodiment the arrows demonstrate the same clamping action but sections 21 and 22 have been removed from the retainer 14 and the outer portions 23 and 24 are dovetailed with a matching undercut in the lands 25 and 26.

Whilst the above has been given by way of illustrative example of the present invention many variations and modifications thereto will be apparent to those skilled in the art without departing from the broad ambit and scope of the invention as set out in the appended claims.

1. A bar connector assembly comprising a body having a bar seat section and a bar retainer moveable relative to the seat section to enable entry of a bar into the assembly, the seat section being adapted to receive and position a second bar relative to an adjacent bar already connected to the assembly, the retainer being moveable between a first position allowing the second bar to be placed on the seat section and a second position to block removal of the second bar from the assembly.

2. A connector assembly according to claim 1 for connecting together opposed reinforcement bars wherein at least one of the bars comprises a loop section, the body of the connector assembly comprising a main body and the retainer comprising a separate bridging member, the main body having an opening, the seat section comprising a loop section seat accessible through the opening so that the loop section may be secured to the main body when positioned on the seat, the bridging member being adapted to bridge across the opening when it is coupled to the main body, the other bar being otherwise connected to the main body opposite the loop section seat, the relative dimensions of the bars, the main body and the bridging member being so chosen and arranged that a rigid portion of the assembly is located between the bars to resist compressive forces which may tend to force the bars toward each other and a further rigid section of the assembly is located in the loop section to resist deformation of the loop section when under tension.

3. A connector assembly according to claim 1 wherein the bar connector assembly enables connection of bars to the assembly so that bars extend from the connector in opposite directions.

4. A connector assembly according to claim 1 wherein the connector assembly is configured and the bars have ends configured so that the ends may be held captive in the assembly.

5. A connector assembly according to claim 1 wherein one of the said bars is a single non-loop bar having an end projection that fits into the main body and is held captive.

6. A connector assembly according to claim 1 wherein the seat section comprises a curved channel into which a curved section of bar is positioned, the channel being a the boundary of an upstanding land filling the inside of the curved section so that upon a load being applied to the bar in tension, the land section aids in retaining the bar in position and inhibits its deformation.

7. A connector assembly according to claim 1 wherein the retainer comprises an edgeways slidable member able to slide into the body after the bar has been inserted, the bar in combination with the seat section and the retainer serving to secure the retainer and thereby the bar in position in the seat section.

8. A connector assembly according to claim 1 wherein the retainer bridges across opposite sides of the body such that the body and retainer have at least one of the bars located between them.

9. A connector assembly according to claim 1 wherein the assembly is symmetrical so that two identically shaped curved bars are connected together by the assembly with the bars so connected together occupying a common plane.

10. A connector assembly according to claim 1 wherein the assembly is symmetrical so that two identically shaped curved bars are connected together by the assembly with the bars so connected together occupying a common plane, the bars being U-shaped ends of projecting rebars.

11. A connector assembly according to claim 1 wherein the main body includes a retainer guideway and the retainer has a guide that travels on the guideway, the guide and guideway being tapered so that the retainer is wedged in position.

12. A connector assembly according to claim 1 wherein the main body includes a retainer guideway and the retainer has a guide that travels on the guideway, the guide being tapered so that the retainer is wedged in position.

13. A connector assembly according to claim 1 wherein the main body includes a retainer guideway and the retainer has a guide that travels on the guideway, the guideway being tapered so that the retainer is wedged in position

14. A connector assembly according to claim 1 wherein any gaps between the bars are filled by the assembly so that compressive movement is blocked and the assembly is symmetrical in side view with the body resisting tension on one side and the retainer bridging the opposite side to resist tension so that force applied to the bars is distributed evenly through the assembly.

15. A connector assembly according to claim 1 wherein the second bar is curved and the retainer generates a clamping force on the curved section of the bar with an outward force applied in the direction of tension and an inward force opposite the outward force.

16. A connector assembly according to claim 1 wherein the second bar is curved and the retainer is wedged against the second bar.

17. A connector assembly according to claim 1 wherein the assembly has two opposed seats and both bars are curved having curved sections in confronting relation when located in operative position and the retainer is wedged between the bars.

18. A connector assembly according to claim 1 wherein the assembly has two opposed seats defined as the inner peripheral portion of opposed lands and both bars are curved having curved sections in confronting relation and wrapped around the respective lands when located in operative position and the retainer is wedged between the bars applying an outward force to the bars and bridges across the lands applying an inward force to each of the lands tending to prevent separation of the lands when tensioned.

19. A connector assembly according to claim 2 wherein the bar connector assembly enables connection of bars to the assembly so that bars extend from the connector in opposite directions.

20. A connector assembly according to claim 2 wherein the connector assembly is configured and the bars have ends configured so that the ends may be held captive in the assembly.

21. A connector assembly according to claim 2 wherein one of the said bars is a single non-loop bar having an end projection that fits into the main body and is held captive.

22. A connector assembly according to claim 2 wherein the seat section comprises a curved channel into which a curved section of bar is positioned, the channel being a the boundary of an upstanding land filling the inside of the curved section so that upon a load being applied to the bar in tension, the land section aids in retaining the bar in position and inhibits its deformation.

23. A connector assembly according to claim 2 wherein the retainer comprises an edgeways slidable member able to slide into the body after the bar has been inserted, the bar in combination with the seat section and the retainer serving to secure the retainer and thereby the bar in position in the seat section.

24. A connector assembly according to claim 2 wherein the retainer bridges across opposite sides of the body such that the body and retainer have at least one of the bars located between them.

25. A connector assembly according to claim 2 wherein the assembly is symmetrical so that two identically shaped curved bars are connected together by the assembly with the bars so connected together occupying a common plane.

26. A connector assembly according to claim 2 wherein the assembly is symmetrical so that two identically shaped curved bars are connected together by the assembly with the bars so connected together occupying a common plane, the bars being U-shaped ends of projecting rebars.

27. A connector assembly according to claim 2 wherein the main body includes a retainer guideway and the retainer has a guide that travels on the guideway, the guide and guideway being tapered so that the retainer is wedged in position.

28. A connector assembly according to claim 2 wherein the main body includes a retainer guideway and the retainer has a guide that travels on the guideway, the guide being tapered so that the retainer is wedged in position.

29. A connector assembly according to claim 2 wherein the main body includes a retainer guideway and the retainer has a guide that travels on the guideway, the guideway being tapered so that the retainer is wedged in position

30. A connector assembly according to claim 2 wherein any gaps between the bars are filled by the assembly so that compressive movement is blocked and the assembly is symmetrical in side view with the body resisting tension on one side and the retainer bridging the opposite side to resist tension so that force applied to the bars is distributed evenly through the assembly.

31. A connector assembly according to claim 2 wherein the second bar is curved and the retainer generates a clamping force on the curved section of the bar with an outward force applied in the direction of tension and an inward force opposite the outward force.

32. A connector assembly according to claim 2 wherein the second bar is curved and the retainer is wedged against the second bar.

33. A connector assembly according to claim 2 wherein the assembly has two opposed seats and both bars are curved having curved sections in confronting relation when located in operative position and the retainer is wedged between the bars.

34. A connector assembly according to claim 2 wherein the assembly has two opposed seats defined as the inner peripheral portion of opposed lands and both bars are curved having curved sections in confronting relation and wrapped around the respective lands when located in operative position and the retainer is wedged between the bars applying an outward force to the bars and bridges across the lands applying an inward force to each of the lands tending to prevent separation of the lands when tensioned.
